(19) United States
(12) Patent Application Publication
(10) Pub. No.: US 2008/0212317 A1
(43) Pub. Date: Sep. 4, 2008

(54) GARAGE LIGHT LUMINAIRE WITH CIRCULAR COMPACT FLUORESCENT EMERGENCY LIGHTING OPTICS

(75) Inventors: Claude Barozzini, Macungie, PA (US); Robert L. Summerford, Selma, TX (US)

Correspondence Address: MIDDLETON & REUTLINGER, 2500 BROWN & WILLIAMSON TOWER, LOUISVILLE, KY, 40202, US

(73) Assignee: Genlyte Thomas Group, LLC, Louisville, KY (US)

(21) Appl. No.: 12/119,757

(22) Filed: May 13, 2008

Related U.S. Application Data
(63) Continuation of application No. 11/535,138, filed on Sep. 26, 2006, now Pat. No. 7,374,310.
Application No. 11/535,138 is a continuation of application No. 10/865,301, filed on Jun. 10, 2004, now Pat. No. 7,121,684.

(51) Int. Cl. F21S 2/00

(52) U.S. Cl. 362/228

(57) ABSTRACT

The present invention relates to a round garage light assembly having a housing with a lamp mounting surface wherein a main HID lamp and an auxiliary circular high output fluorescent lamp are mounted. The auxiliary lamp is mounted centrally within the assembly and above the photometric center of the high intensity discharge lamp so that the light pattern emitted from the auxiliary lamp is symmetrical and the auxiliary lamp does not shadow the light emitted from the HID lamp.

### BACKGROUND OF THE INVENTION

1. Field of the Invention

This invention relates to the lighting arts, and in particular to an electronic auxiliary lighting system for a high intensity discharge lamp. More particularly, the auxiliary lighting system of the present invention uses as a light source a high output compact fluorescent lamp.

2. Description of Related Art

A high-intensity discharge (HID) lamp will extinguish when power to the HID lamp is interrupted. Momentary power interruptions, such as a lightning strike or someone inadvertently hitting the on/off switch, will cause the HID lamp to extinguish. An extinguished HID lamp will not immediately re-ignite upon the restoration of power to the HID lamp because gases within the HID lamp must be cooled before the HID lamp will re-ignite. With the power restored, restarting a hot HID lamp can take several minutes. Even when they are cool, and easy to start, HID lamps still take up to 2 minutes to come to full bright after they are ignited.

The garage building industry puts a great deal of stock in emergency lighting standards. The industry likes to see a certain minimum amount of light along path of egress in their structures during power interruptions. Accordingly, auxiliary lighting control circuitry has been used for automatically lighting an auxiliary light source, such as an incandescent lamp, following a brief power interruption of a HID lamp. It is known in the art to use quartz lamps to meet these emergency lighting requirements. Round and square garage lights having a HID lamp as a primary light source and a quartz auxiliary lamp have been used for many years. The premise is that when the HID lamp, located at the center of the fixture, is not on the quartz lamp, which is typically a smaller cylindrical incandescent lamp mounted to the side of the HID lamp, is lit to provide emergency illumination. However, there are inherent problems with these current practices of providing auxiliary light to garage lighting systems.

The quartz lamps that are typically used as auxiliary lamps are short lived and are very inefficient in converting electric power into lumens. This causes problems with continued reliability, maintenance, and the ability to meet auxiliary lighting needs. Another problem associated with these current practices is that the quartz lamps are not located at the photometric center of the fixture. This causes the pattern of light projected from the auxiliary lamp to not be uniform and thus portions of the lighted area are only dimly lit. Additionally, during normal operation the quartz lamp mounted on one side of the fixture blocks light from the HID lamp located at the center of the fixture. This causes the quartz lamp, during normal operation of the HID lamp, to form a shadow on the area being lit. It has also been found that emergency incandescent lamp sources are inherently glary and consistently mounted off of the centerline of the fixture, causing the luminaire to be aesthetically unappealing.

What is needed in the garage lighting industry is an auxiliary lamp system that provides emergency light without the problems found in the current systems.

### SUMMARY OF THE INVENTION

An object of the present invention is to provide a luminaire having both a main lamp and an auxiliary lamp where the auxiliary lamp efficiently and reliably provides illumination when the main lamp fails to provide adequate illumination.

Another object of the present invention is to provide a luminaire having an auxiliary and a main lamp that provide uniform illumination without asymmetries to the area below.

A further object of the present invention is to provide a luminaire that has a main lamp and an auxiliary lamp where neither the main lamp or the auxiliary lamp cause shadowing.

It is yet another objective of the present invention to provide a luminaire having a main lamp and an auxiliary lamp so that the luminaire is aesthetically appealing.

These objects and others are accomplished according to the present invention by providing a luminaire for illuminating a wide area and having an auxiliary lamp that emits adequate light efficiently and uniformly without causing shadowing of the light emitted from the main lamp and is aesthetically appealing.

The luminaire of the present invention includes a circular or rounded housing having a lower reflective lamp mounting surface. A main light source, preferably a high intensity discharge (HID) lamp, is centrally mounted onto the lamp mounting surface and extends downward. This vertical arrangement provides for optimum illumination efficiency and life of the HID lamp. An auxiliary lamp is also mounted onto the lamp mounting surface. This auxiliary lamp may be a high output compact fluorescent circular lamp and is located centrally about the photometric center of the luminaire. The auxiliary lamp surrounds at its center the main lamp mount and perhaps a portion of the main lamp and may have its optical center closer to the lamp mounting surface of the housing than the optical center of the main lamp. Additionally, the luminaire has a main barrel shaped reflector that that surrounds a central portion of the main lamp and is mounted at a distance from the lamp mounting surface so that a large portion of the light being emitted from the auxiliary lamp is reflected to the area below by the barrel reflector. The downward portion of the light being emitted from the auxiliary lamp and much of the light reflected from the lamp mounting surface is redirected by the barrel reflector to provide an illumination pattern similar to the pattern created by the normal operation of the HID lamp. The luminaire may also have a lens attached to the lamp mounting surface that encloses the auxiliary lamp, main lamp, and barrel reflector. This lens may have prisms that spread the light being emitted from the auxiliary lamp, main lamp, and light reflected from the lamp mounting surface and barrel reflector to desired areas to be illuminated.

### DESCRIPTION OF THE DRAWINGS

FIG. 1 is a perspective view of the luminaire of the present invention showing the high output compact fluorescent circular auxiliary lamp, main HID lamp, housing, lamp mounting surface, and their placement within the luminaire.

FIG. 2 is a lower perspective view of the luminaire in FIG. 1 showing a barrel reflector and its location within the luminaire.

FIG. 3 is an exploded view of the luminaire in FIG. 2 showing the relationship of the components of the luminaire.

FIG. 4 is a view of the high output compact fluorescent circular auxiliary lamp, mount, and mounting brackets of the present invention.

FIG. 5 is a side view of the round garage light of the present invention having a lens.

FIG. 6 is a perspective view of the round garage light of the present invention having an alternative embodiment of a lens.

FIG. 7 is a photometric comparison of light levels achieved by the auxiliary lamps in the prior art and the light levels achieved by the auxiliary lamp of the present invention.

FIG. 8 is the photometric data of light levels achieved by the auxiliary lamps in the prior art.

FIG. 9 is the photometric data of light levels achieved by the auxiliary lamp in the present invention.

### DETAILED DESCRIPTION OF THE PREFERRED EMBODIMENTS

The present invention may best be understood by reference to the following description taken in conjunction with the accompanying figures. The figures illustrate specific embodiments in which the invention may be practiced and it is to be understood that other embodiments may be utilized as structural changes may be made without departing from the scope of the present invention.

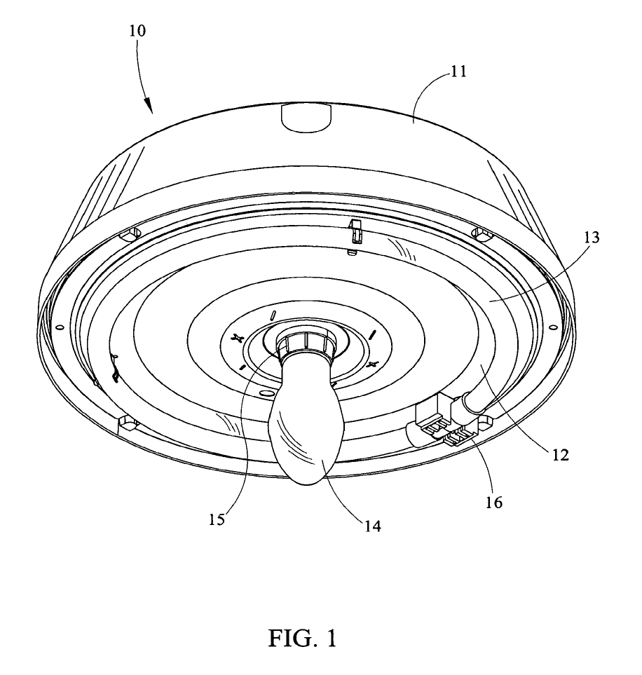

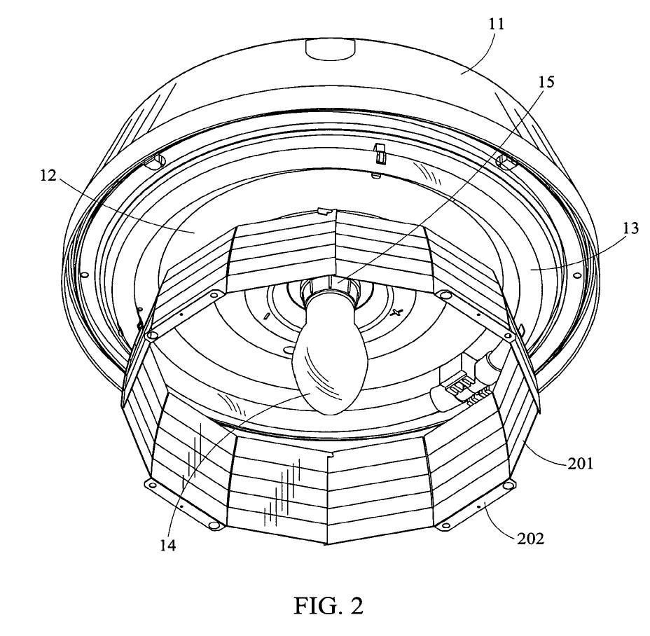

FIG. 1 is a perspective view of the round garage light of the present invention showing the high output compact fluorescent circular auxiliary lamp 12, main HID lamp 13, housing 10, lamp mounting surface 11, and their placement within the luminaire.

The circular housing 10 may hold the wiring, ballasts, auxiliary light switch, battery, and any other electrical equipment that may be associated with the main lamp 13 and auxiliary lamp 12. On the bottom of housing 10 is a lamp mounting surface 11. This lamp mounting surface 11 in this design is round and covers most of the lower portion of housing 10 and may serve as the lower wall of housing 10. Lamp mounting surface 11 may have an anodized reflective surface and as shown in the embodiment in the figures typically has circular ridges and troughs that reflect the light from the main lamp 13 and auxiliary lamp 12 to the desired area.

Main lamp 13 is a HID lamp that is mounted into lamp mount 14 which is centrally located within lamp mounting surface 11. Lamp mount 14 is attached to lamp mounting surface 11 at a recessed center of lamp mounting surface 11 so that light emitted from lamp 13 is at a specific predetermined distance from lamp mounting surface 11.

Auxiliary lamp 12, a high output compact fluorescent circular lamp, is mounted annularly around lamp mount 14 and main lamp 13. Auxiliary lamp 12 is mounted to lamp mounting surface 11 with circular lamp mount 15. Circular lamp mount 15 is attached near the outer edge of lamp mounting surface 11 at a non-recessed portion at a specific predetermined distance from lamp mounting surface 11 and provides an electrical connection to the lamp 12 electrodes and power supply, not shown.

Main lamp 13 extends downwardly from lamp mounting surface 11 while auxiliary lamp 12 is a circular lamp that has its optical center closer to lamp mounting surface 11. This configuration allows main lamp 13 to project its light downwardly and radially through the use of mounting surface 11 and reflector 201 without having shadowing or refraction from auxiliary lamp 12 since main lamp 13 has its optical center below auxiliary lamp 12. Additionally, both auxiliary lamp 12 and main lamp 13 have an optical center centrally located with lamp mounting surface 11. This configuration provides symmetry to the luminaire which improves the consistency in the direction and pattern of light being emitted from the luminaire when the source of light is changed between HID lamp 13 and auxiliary lamp 12. The symmetry of lamp 13 and lamp 12 also improves the aesthetics of the luminaire.

FIG. 2 is a perspective view of the luminaire of the present invention showing the placement of the barrel reflector 201 within the luminaire. Barrel reflector 201 has an inner reflective surface and surrounds a portion of main lamp 13. Barrel reflector 201 reflects the radial light being emitted from main lamp 13 to the desired area below. In the embodiment of the barrel reflector 201 shown, the inner reflective surface has facets to disperse the light within the desired area to be lit. Barrel reflector 201 is mounted at a specific distance from lamp mounting surface 11 so that a large portion of light emitted from main lamp 13, auxiliary lamp 12, and reflected by lamp mounting surface 11 encounters the inner reflective surface of barrel reflector 201 and is reflected to the desired area below. Therefore, operation of either HID lamp 13 or auxiliary lamp 12 enables the luminaire to produce a consistent and even light pattern on the area below.

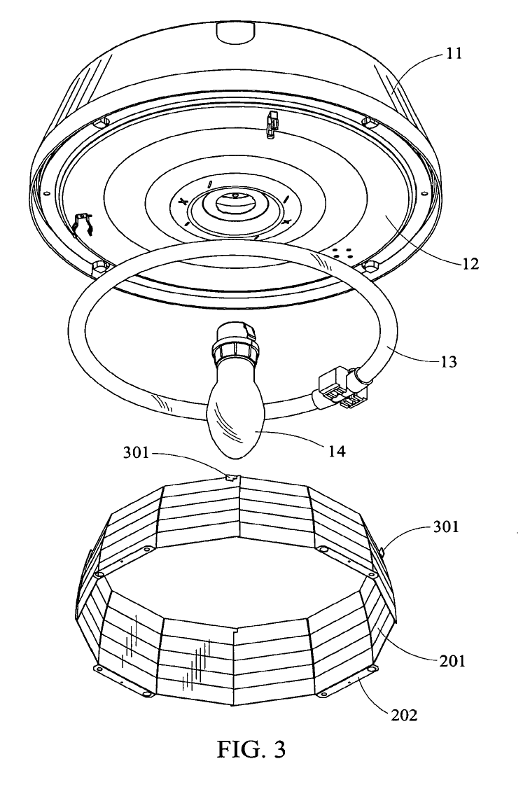

FIG. 3 is an exploded view of the luminaire of the present invention showing the relationship of the components of the luminaire. Housing 10 and lamp mounting surface 11 are shown as being joined to form an enclosure. In this embodiment lamp mounting surface 11 is a reflective bottom surface of housing 10. It should be understood that housing 10 may have a bottom surface to which a reflective lamp mounting surface 11 may be attached. This exploded view also shows auxiliary lamp 12 and main lamp 13 in a spatial relationship where it can be seen that the light being emitted from main lamp 13 is not impeded or refracted by auxiliary lamp 12 and hence does not create a shadow.

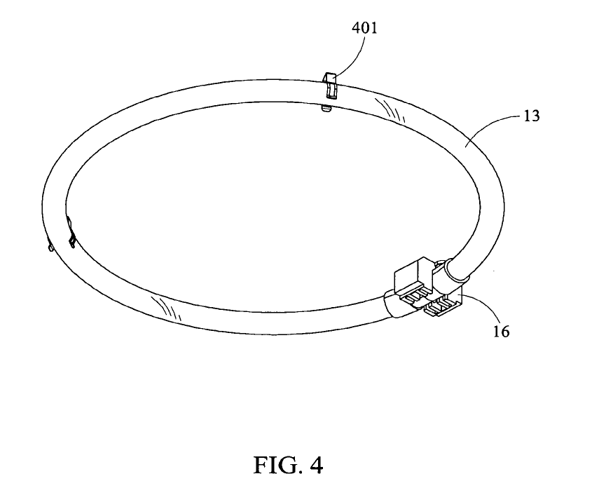

FIG. 4 is a view of the high output compact fluorescent circular auxiliary lamp 12, mount 15, and mounting brackets 401. In this embodiment, mounting brackets 401 and auxiliary mount 15 are arranged at 120° intervals about the circular auxiliary lamp.

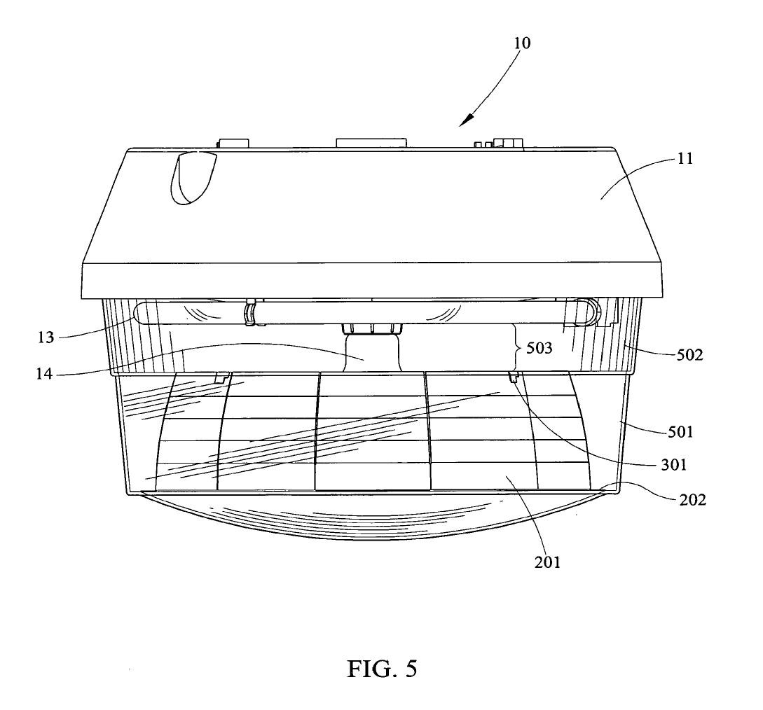

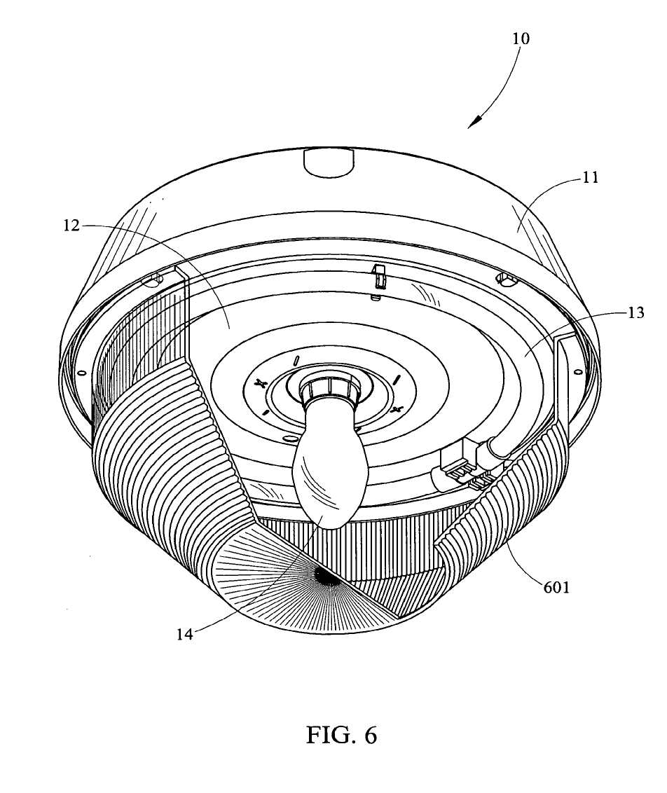

FIGS. 5 and 6 are views of the luminaire of the present invention having alternative embodiments of a lens that are a part of the present invention. Specifically FIG. 5 shows a side view of the round garage light of the present invention having a lens 501. Lens 501 has prisms on its inner surface located above barrel reflector 201. These prisms are vertically extending ridges having sides at a 45° toward the optical center of the luminaire. FIG. 6 shows perspective view of the round garage light of the present invention having lens 601. Lens 601 may have prismatic surfaces on an interior side to direct light emitted from the lamps 12 and 13, reflective surface 11, and barrel reflector 201 to desired areas below.

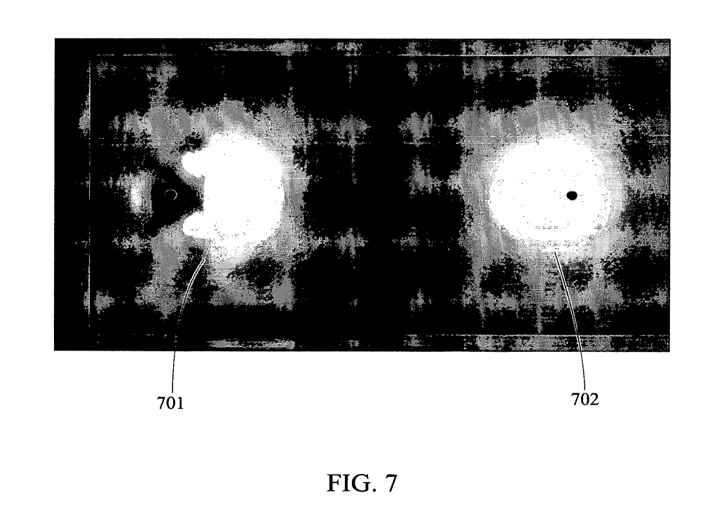

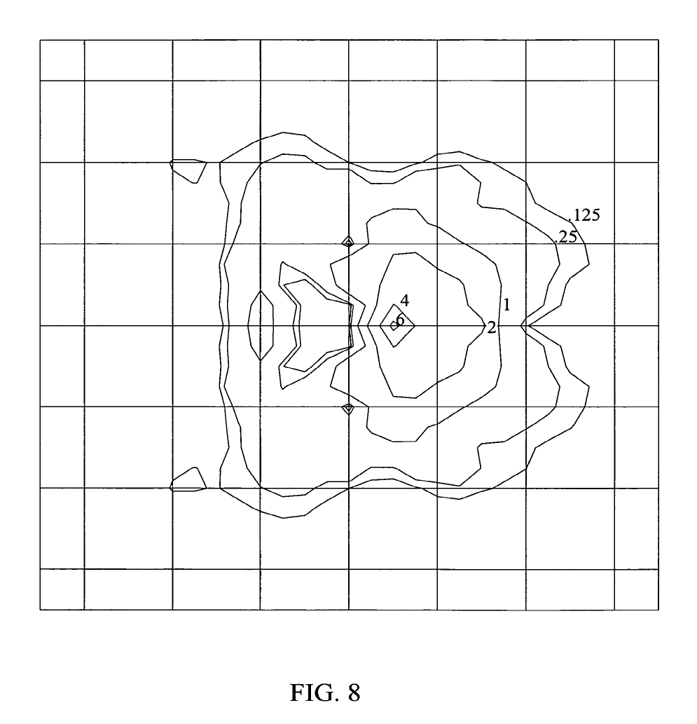

FIG. 7 is a photometric comparison of light levels achieved by the auxiliary lamps in the prior art 701 and the light levels achieved by the auxiliary lamp of the present invention 702. Photometric tests were performed to verify symmetric distribution of light from the auxiliary or emergency lamp 12. These lighting patterns were generated by having the luminaires ten feet from the floor area below. The dark circle in the prior art light distribution 701 and the light distribution found in the present invention 702 designate the location of the luminaire above the light pattern. The light pattern of the prior art 701 is asymmetrical since the quartz auxiliary lamps are not centrally located about the photometric center of the luminaire. Additionally, the main HID lamp and mount shadow a portion of light being emitted from the quartz auxiliary lamp of the prior art. Conversely, the light pattern 702 emitted from the auxiliary lamp 12 of the present invention is symmetrical and has no shadowing from HID lamp 13 or mount 14. The barrel reflector 201 and lamp mounting surface 11 reflect the light emitted from auxiliary lamp 12 evenly onto the surface below.

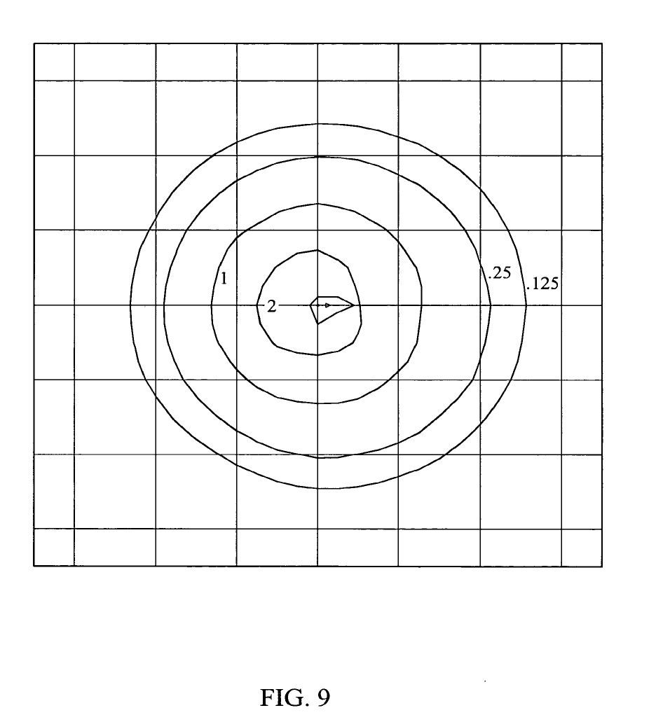

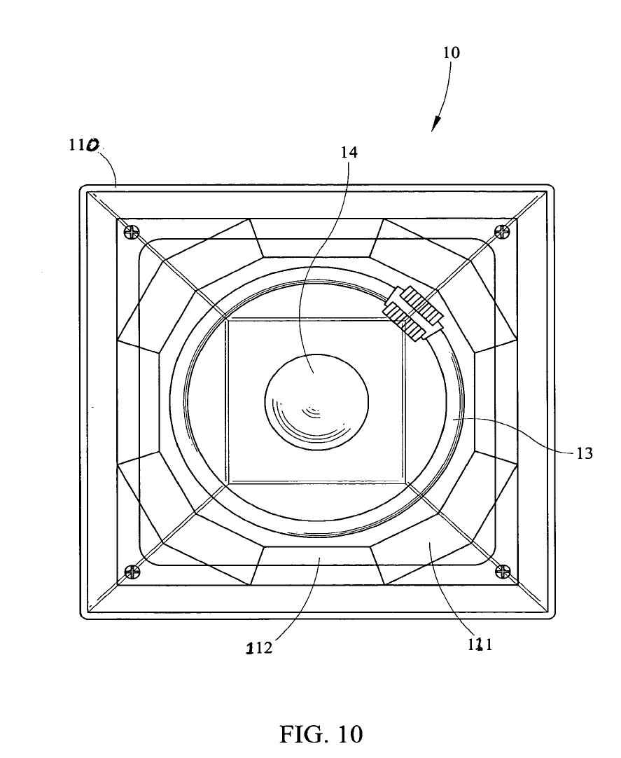

FIGS. 8 and 9 are isofootcandle representations of the comparison of light levels achieved by the auxiliary lamps in the prior art FIG. 8 and the light levels achieved by the auxiliary lamp of the present invention as shown in FIG. 9. The grid lines in these figures represent ten square feet of floor area while the isometric lines represent footcandles of illumination of the lighting patterns in FIG. 7. This numeric representation of the photometric data of light levels achieved by the quartz auxiliary lamps of the prior art in FIG. 8 and the photometric data of light levels achieved by the auxiliary lamp 12 of the present invention as shown in FIG. 9 clearly shows the symmetrical illumination of the present invention as compared to the asymmetrical illumination of the prior art. The illumination pattern of the prior art FIG. 8 has areas of intense illumination (>6 footcandles) and areas of almost no illumination (<125 footcandles) below the fixture. The illumination pattern of the present invention FIG. 9 is symmetrical and void of the bright and dare areas found in the prior art FIG. 8.

The Round Garage Light With Circular Compact Fluorescent Emergency Lighting Optics of the present invention is an aesthetically appealing luminaire that has both a main lamp and an auxiliary lamp where the auxiliary lamp efficiently and reliably provides uniform illumination without asymmetries or shadows to the area below. The luminaire of the present invention meets the objectives previously set forth by having a high output compact fluorescent auxiliary lamp, HID main lamp, and a barrel reflector each being vertically centered along a lamp mounting surface. The horizontal placement of the high output compact fluorescent auxiliary lamp, HID main lamp, and a barrel reflector in relation to the reflective lamp mounting surface provides for an efficient and consistent distribution of light to the area below.

We claim:

1. A garage light assembly, comprising:
a housing having a primary reflector and a lamp mounting surface,
a circular high output fluorescent lamp symmetrically supported by said lamp mounting surface, and
a high intensity discharge lamp and socket combination mounted centrally to said reflector,
wherein a portion of said lamp and socket combination extends substantially through a center portion of said circular high output fluorescent lamp,
said circular high output fluorescent lamp and said high intensity discharge lamp each having a configuration and orientation providing a substantially consistent illuminated pattern on a lighted surface when the source of light of said garage light assembly is switched from said high output fluorescent lamp to said high intensity discharge lamp.

2. A garage luminaire, comprising:
a primary high intensity discharge lamp mounted symmetrically to a luminaire housing and
an auxiliary lamp mounted symmetrically to said luminaire housing
wherein said auxiliary lamp is nearer to said luminaire housing than said high intensity discharge lamp,
said housing having at least one reflective surface proximate said lamps.

3. The garage luminaire in claim 2 wherein said luminaire has a barrel reflector mounted symmetrically to said luminaire housing substantially encircling said high intensity discharge lamp, said barrel reflector having an open top near said housing of a first radius and an open bottom of a second radius, said first radius being less than said second radius, and said open top of said barrel reflector being a greater distance from said housing than said auxiliary lamp.

4. A garage luminaire comprising:
a primary high intensity discharge lamp socket mounted to a luminaire housing,
said luminaire housing having a reflective surface proximate said primary high intensity discharge lamp socket;
an auxiliary lamp socket mounted to said luminaire housing; and
a means for providing symmetrical reflective light from said auxiliary lamp.

5. The garage luminaire of claim 4 wherein said means for providing uniform symmetrical light from said auxiliary lamp is comprised of having an auxiliary lamp centrally mounted within said garage luminaire.

6. The garage luminaire of claim 4 wherein said means for providing uniform symmetrical light from said auxiliary lamp is further comprised of having a barrel reflector mounted to said luminaire housing substantially encircling a light emitting portion of said high intensity discharge lamp and having an open top of a first radius and an open bottom of a second radius wherein said second radius is greater than said first radius.

7. A garage luminaire with emergency lighting, comprising:
a housing having a base reflector surface;
a round high output fluorescent emergency lamp mounted centrally to base reflector surface
wherein said emergency lamp is at a first distance from said base reflector surface;
and a main high intensity discharge lamp mounted centrally to said base reflector surface and having a central point being a second distance from said base reflector surface, said second distance being greater than said first distance.

8. A combination emergency and garage light, comprising:
a housing having a reflective mounting surface;
a circular secondary light source mounted adjacent said reflective mounting surface;
a high intensity discharge lamp socket mounted substantially centrally to said reflective mounting surface and said circular secondary light source.
